(19) United States
(12) Patent Application Publication
(10) Pub. No.: US 2015/0206047 A1
(43) Pub. Date: Jul. 23, 2015

(54) METAL CARD WITH RADIO FREQUENCY (RF) TRANSMISSION CAPABILITY

(71) Applicants: John Herslow, Scotch Plains, NJ (US); Adam Lowe, Hillsborough, NJ (US)

(72) Inventors: John Herslow, Scotch Plains, NJ (US); Adam Lowe, Hillsborough, NJ (US)

(21) Appl. No.: 14/159,407

(22) Filed: Jan. 20, 2014

(51) Int. Cl. G06K 19/077; H01Q 7/00

(52) U.S. Cl. CPC G06K 19/07779; H01Q 7/00

(57) ABSTRACT

A smart card with a metal layer which can capture radio-frequency (RF) signals via an antenna system is made operable by modifying the metal layer to enable passage of RF signals through the metal layer and/or by introducing a ferrite layer to enhance the efficient reception/transmission of RF signals by the antenna system. In one embodiment apertures are formed in and through the metal layer to allow RF signals to pass through the metal layer without negatively impacting the decorative or esthetic and/or reflective nature of the metal layer. These modifications allow for dual interface and contactless smart card formats. In other embodiments of the invention, a ferrite layer is formed between the metal layer and the inductors/antennas mounted within the smart card to enhance the efficient reception/transmission of RF signals.

This application claims priority based on a provisional application titled METAL CARD WITH RADIO FREQUENCY (RF) TRANSMISSION CAPABILITY bearing Ser. No. 61/754,776 filed Jan. 21, 2013 whose teachings are incorporated herein by reference.

### BACKGROUND OF THE INVENTION

This invention relates to a “smart” card having at least one metal layer, produced in contactless and dual interface formats.

A smart card is a card that includes a computer chip (also referred to as a microprocessor or integrated circuit, IC) which contains either a memory and/or a microprocessor device and associated electronic circuitry that stores and transacts data. This data is usually associated with either value, information, or both and is stored and processed within the card's computer chip. The card data is transacted via a card reader that is part of a computing system. Systems that are enhanced with smart cards are in use today throughout several key applications, including healthcare, banking, entertainment, and transportation, among others.

Smart cards may be of: (a) the “contactless” type (i.e., the computer chip is part of a module or assembly which includes inductors/antennas and is operable by means of these inductors/antennas coupling RF signals between the smart card's embedded computer chip and a card reader); or (b) of the “contact” type (operable by means of direct physical contacts between the smart card and a card reader); or (c) of the dual interface type operable as contactless and/or contact type.

A contactless smart card is characterized in that the card includes a module which communicates with, and is powered by, an associated card reader, in proximity to the smart card, through RF induction technology (at data rates of, for example, 106-848 kbit/s). These contactless smart cards do not have an internal power source and are contactless in that they do not need to make direct contact to a reader. Instead, they use inductors and antennas to capture some of the radio-frequency interrogation signal produced by the associated card reader, rectify it, and use it to power the card's electronics.

Contactless smart cards that do not require physical contact between card and reader are becoming increasingly popular for virtually every conceivable use (e.g., payment and ticketing applications such as mass transit and motorway tolls, in personal identification and entitlement schemes at regional, national, and international levels, citizen cards, drivers' licenses, and patient card schemes, biometric passports to enhance security for international travel, etc. . . . ).

It has also become very desirable and fashionable to make cards with one or two metal layers. The metal layer provides a decorative pattern and/or reflective surface enhancing the card's appearance and aesthetic value. This is especially desirable for use by high-end customers.

However, a problem arises when using a metal layer with a contactless smart card in that the metal layer interferes with or prevents the capture of radio-frequency (RF) interrogation signals and renders the contactless smart card useless.

### SUMMARY OF THE INVENTION

It is an object of the invention to manufacture a smart card with a metal layer which can capture radio-frequency (RF) signals and be fully operable by either modifying the metal layer and/or by introducing a ferrite layer to enhance the efficient reception/transmission of RF signals. This smart card may be produced in a contactless or dual interface format.

It is another object of the invention to manufacture smart cards with a modified metal layer such that the smart card can function as a contactless or dual-interface card.

In certain smart cards embodying the invention, the problem associated with a metal layer interfering or blocking the reception and transmission of RF signals (by the inductors/antennas mounted within the smart card electronics) is overcome by forming apertures in and through the metal layer which allow RF signals to pass through the metal layer without negatively impacting the decorative or esthetic and/or reflective nature of the metal layer.

In one embodiment, thru-holes of very small diameter are formed in an area overlying and surrounding the chip/module where the holes are virtually imperceptible to a viewer of the card.

In another embodiment, the apertures are formed to generate a pattern which enhances the decorative effect of the metal layer. In other embodiments, the apertures take the form of slits extending through the metal layer.

In other embodiments of the invention, a ferrite layer is formed between the metal layer and the inductors/antennas mounted within the smart card to enhance the efficient reception/transmission of RF signals.

### BRIEF DESCRIPTION OF THE DRAWINGS

In the accompanying drawings which are not drawn to scale, like reference characters denote like components, and

FIGS. 1, 1A and 18B are simplified cross-sectional diagrams of a contactless smart card with a metal layer modified in accordance with the invention;

FIG. 1C is still another simplified cross-sectional diagram of a dual interface smart card embodying the invention;

FIG. 2 is a top view of two intermediate layers of the card of FIG. 1 including a schematic rendition of the inductive coupling between the “card” antenna in one layer of the card and the module/chip antenna in another layer of the card;

FIG. 2A is an isometric blowup of the layers of a smart card embodying the invention;

FIGS. 3 and 3A are top views of the metal layer of a smart card with holes or patterns formed therein in accordance with the invention;

FIG. 4 is a cross-sectional diagrams of a smart card embodying the invention having a metal layer and a ferrite layer enhancing the reception and transmission of RF signals to overcome the RF attenuating effect of the metal layer;

FIG. 4A is an exploded isometric diagram of the stacking of the layers shown in FIG. 4 view of

FIG. 4B is a cross-sectional diagram of a smart card embodying the invention having a metal layer and a ferrite layer enhancing the reception and transmission of RF signals to overcome the RF attenuating effect of the metal layer;

FIG. 4B1 is an exploded isometric diagram of the three (3) referenced layers shown in FIG. 4B;

FIG. 4C is a cross-sectional diagram of a smart card with a ferrite layer embodying the invention enhancing the reception and transmission of RF signals;

FIGS. 5 and 5A are cross sectional diagrams showing a configuration in which the metal layer is modified and the module is modified to enable a smart card with a metallic layer to enable a card to be accessed in a contactless manner or by making contact with a reader; and

FIGS. 6 and 6A show a cross section and top view respectively of a metal clad card embodying the invention with dimensions given in inches.

### DETAILED DESCRIPTION OF THE INVENTION

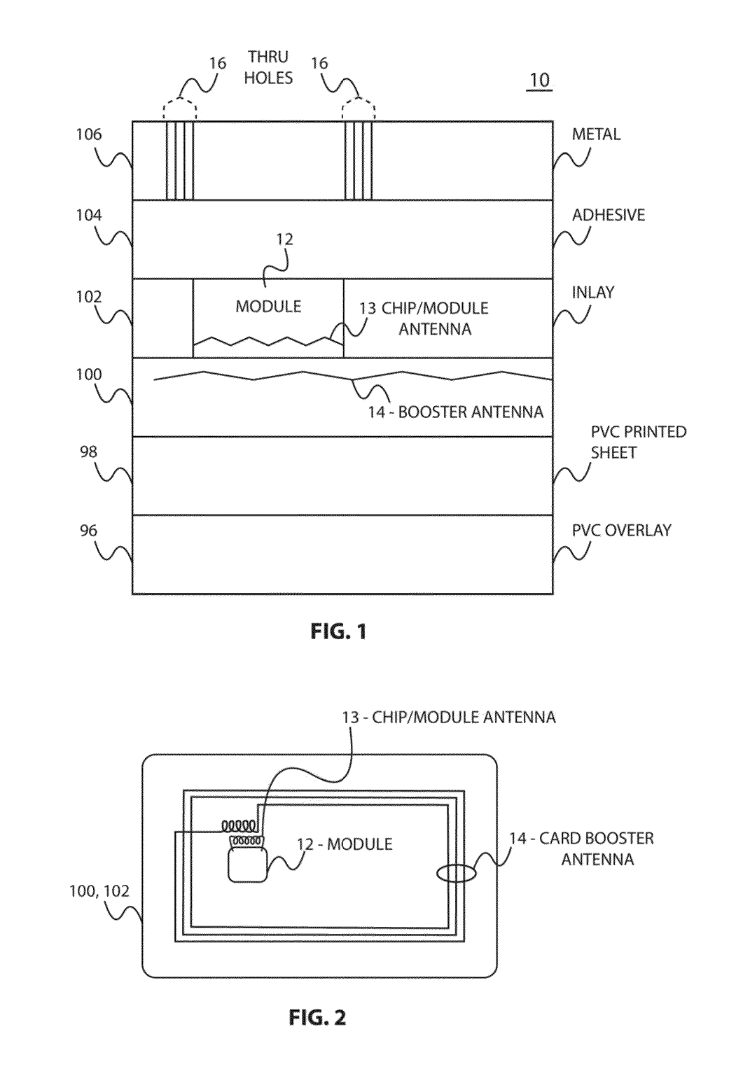

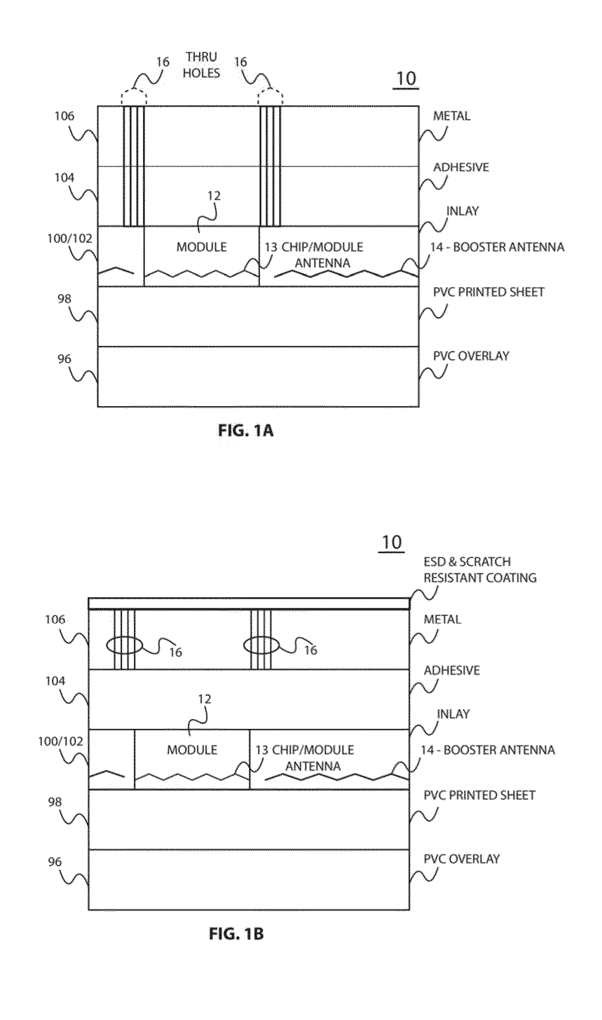

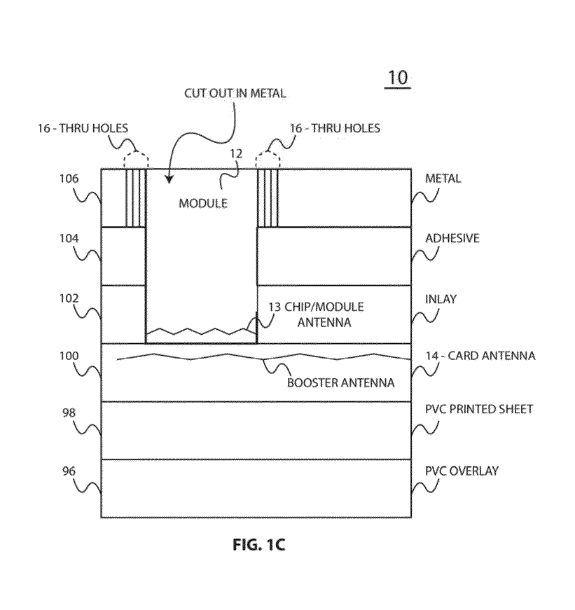

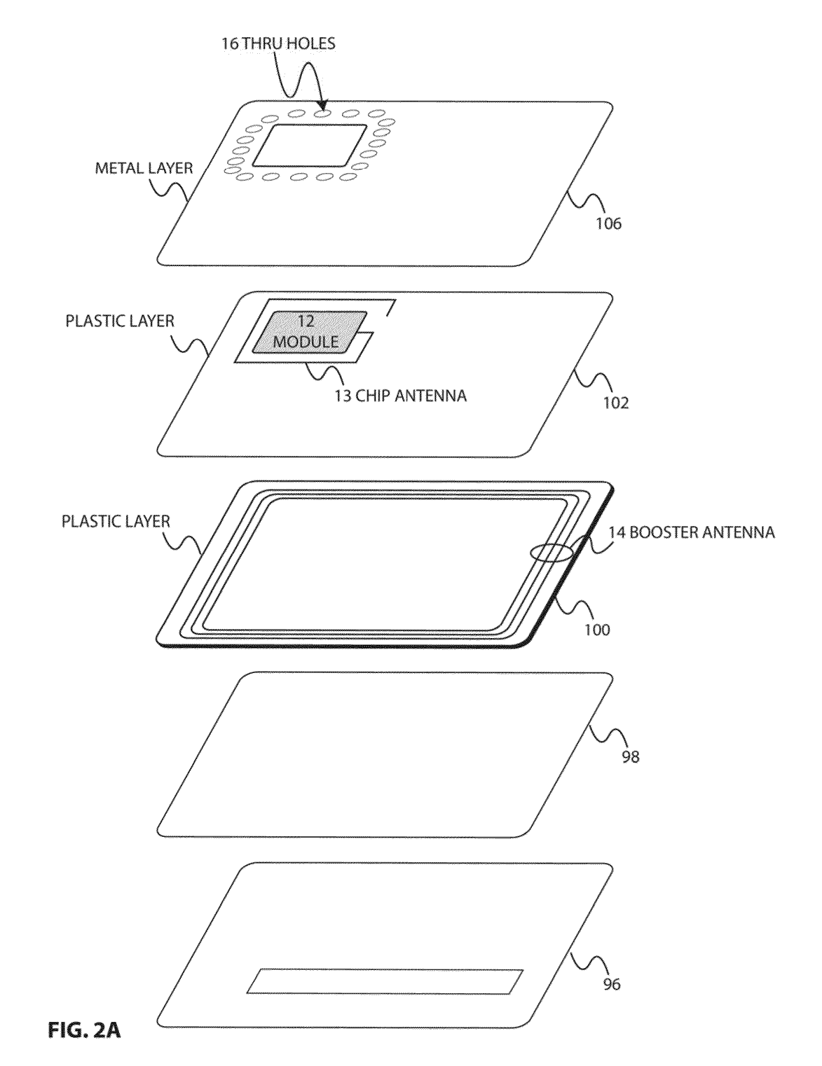

As shown in FIGS. 1, 1A, 1B, 2, and 2A, a smart card 10 embodying the invention includes: (a) a module 12 which contains a microprocessor chip and a module/chip antenna 13 coupled to the chip. These modules are commercially available and may be, for example, purchased from NXP, SMARTRAC, Infineon, or Inside Secure; and (b) a metal layer 106 which is shown in the figures to be located above the module at or near the top side of the card 10. [Note the card layers may be inverted so that the metal layer is at the bottom.]

In FIG. 1 the card 10 includes a PVC overlay layer 96 over which is formed a PVC layer 98 which may include selected printed information. A layer 100 is formed above layer 98 and includes a booster or card antenna 14 which is designed to capture energy from an associated card reader (not shown) and to communicate with the card reader. A layer 102 is formed above layer 100 and includes a module/microprocessor 12 which includes a chip/module antenna 13. Antenna 13 (which may be referred to as the module or chip antenna) is designed to be coupled inductively to antenna 14 (which may be referred to as the “booster or “card” antenna). The use of a module 12 with its own antenna 13 enables the module 12 to be inductively coupled to the card/booster antenna 14 without the need for wire bonding between them. This increases the reliability of the card and also makes its fabrication easier and cheaper. An adhesive layer 104 is used to attach the metal layer 106 to layer 102.

In cards embodying the invention, the metal layer 106 may range from a thickness of less than 1 mil (0.001 inches) to more than 30 mils (0.03 inches). It is noted that the present invention includes the use of “thick” metal layers (e.g., more than approximately 10 mils). This is significant since it requires laminating a thick metal layer with various plastic layers versus working with a thin metal foil which is typical in the industry. This is achieved by developing laminating processes and coating processes to make all the layers work together. Generally any type of metal may be used to practice the invention. This includes any metal which can be milled and/or vapor and chemically deposited. These metals are typically but not limited to ferric, cupric, and noble metal alloys, most transition metals, noble metals, and some lanthanides and actinides.

As noted above the metal layer interferes with (or prevents) the passage of radio frequency (RF) signals. The problem is addressed in cards embodying the invention by forming thru holes (apertures) 16 in the metal layer 106. The antenna system which includes module antenna 13 and booster antenna 14 functions to capture necessary RF signals passing through thru-holes 16 to operate the computer chip. However, it should be appreciated that under certain favorable conditions the need for a booster antenna may not be necessary. The module antenna and the associated computer chip in module 12 may be sufficiently sensitive to capture the RF signals passing through the holes 16.

In FIG. 1A the module 12, the module antenna 13 and the booster antenna 14 are located on the same level (i.e. on plastic layer identified as 100/102). Otherwise, the card functions in a similar manner to that of FIG. 1. The card is configured to operate in a contactless format with the RF signals passing though the apertures (thru-holes) 16 to the antenna system comprising antennas 13 and 14.

FIG. 1B is like FIG. 1A except that there is shown a protective coating overlying the metal layer. The protective coating includes an electrostatic discharge (ESD) layer and/or a scratch resistant coating. This type of protective coating would be provided on all cards embodying the invention. The card may be configured in a contactless format as shown.

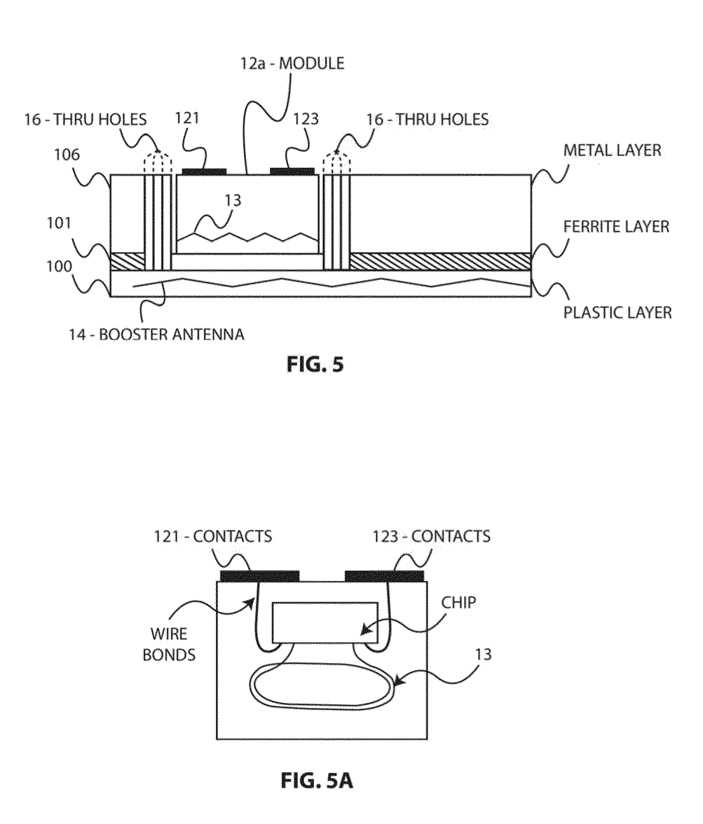

Alternatively, cards embodying the invention may be configured as a dual-interface configuration where the metal is cut out over the module, and contacts present on the module or chip are exposed and made available for direct contact. This is illustrated in FIGS. 1C and 5 which show that cards may be made with a cut out through the metal in the area overlying the module, with the module located within the cut out for a dual interface format as shown in FIG. 5. When the metal portion of the metal layer 16 overlying the module is removed (cut out) direct contact can be made with the computer chip so the smart card can be used in a contactless mode or a contact mode. FIG. 1C shows through holes 16 and a cut out region for the module 12. In FIG. 5, module 12a is made to be flush with the top of metal layer 16. Where the cut out in the metal layer 16 is made larger than the module, it may be unnecessary to make the through holes since a passage way for RF signals is created by the spacing between the module and the walls of the cut out.

FIG. 2 shows a top view of a “card” antenna 14 (e.g., 2, or more, loops of a thin strand of copper wire) which would be mounted on top of, or within, layer 100 and be disposed around and along the outer periphery of layer 100. The antenna 14 is fixedly attached in any suitable manner to the top surface of layer 100. As shown schematically, the card antenna 14 is inductively coupled to the antenna 13 of module (microprocessor) 12 which includes circuitry responsive to energy received by the antenna 13 from antenna 14 which communicates with a card reader (not shown). As already noted, module antenna 13 and booster antenna 14 may be formed on the same level or on different level as long as there is appropriate inductive coupling between the two antennas.

FIG. 2A shows the stacking of the layers of a smart card shown in cross section in FIG. 1. In this configuration the module antenna and the booster antenna are shown to be on two different plastic layers (100, 102). However, it should be appreciated that the booster antenna could be formed on the underside of layer 102 or contained within a separate layer between layers 98 and 102. The thru holes 16 overly and surround the area occupied by module 12.

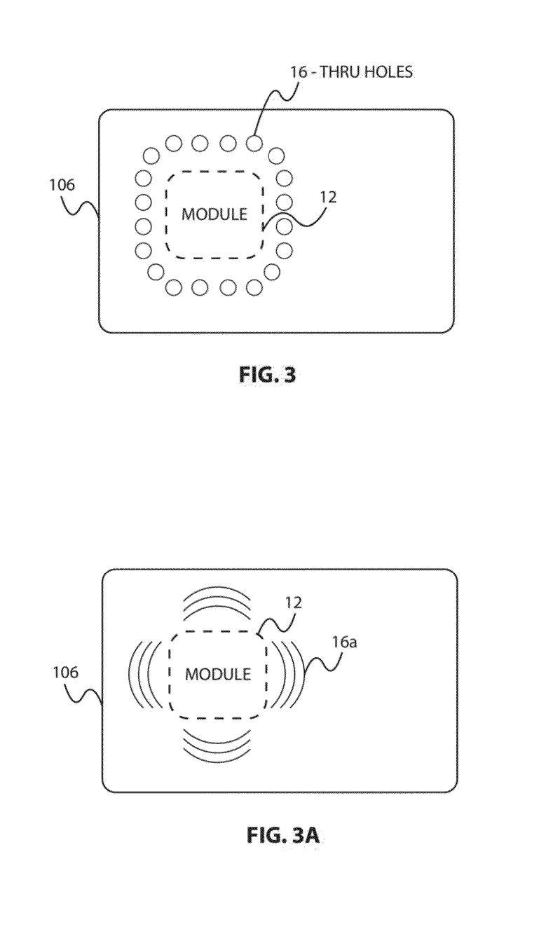

As shown in FIG. 3, the thru holes 16 may be formed in an area of metal layer 106 surrounding the location of module 12 which is positioned below the metal layer. The thru holes may be, for example, 0.005 inches in diameter. These holes are so small that they can be made hardly visible so as not to detract from the appearance of the card. Thru holes 16 have been found to be sufficient in size (e.g., 0.005 inches) and number (e.g., 30) to allow the magnetic field from the card antenna 14 to be inductively coupled to the module antenna 13. Thru-holes with diameters as large as 0.02 inches have been made without significantly altering the appearance of the metal layer. The thru holes 16 provide flux passage to connect the module antenna 13 to the card's antenna 14. Thus, the signals from the card reader (not shown) can pass to the card antenna and then to the module antenna to activate the circuitry in module 12. Likewise, signals from the module 12 can be passed via module antenna 13 to the card antenna 14 and then to the card reader. This allows bidirectional signal transfer between antenna 14 and the module 12 (via antenna 13) and between the module 12 and the card reader (not shown). Note that the presence of the holes may be readily masked by arranging them to form a pattern or eye pleasing design.

Note that the thru holes 16 may continuous slits as shown in FIG. 3A. Alternatively, they may have any suitable shape and from any decorative pattern. Apertures extending through the metal layer may be arranged to form a pattern or design such that the decorative and or aesthetic value of the metal layer is kept while creating a path for RF signals and associated magnetic field to pass through. In FIGS. 3 and 3A the outline of the module 12 underlying the metal layer is shown with dashed lines. As shown in FIGS. 1C and 5 the portion of the metal overlying the module 12 may be cut away exposing the module 12, its associated antenna 13, and the booster antenna 14 to a higher degree of RF signals.

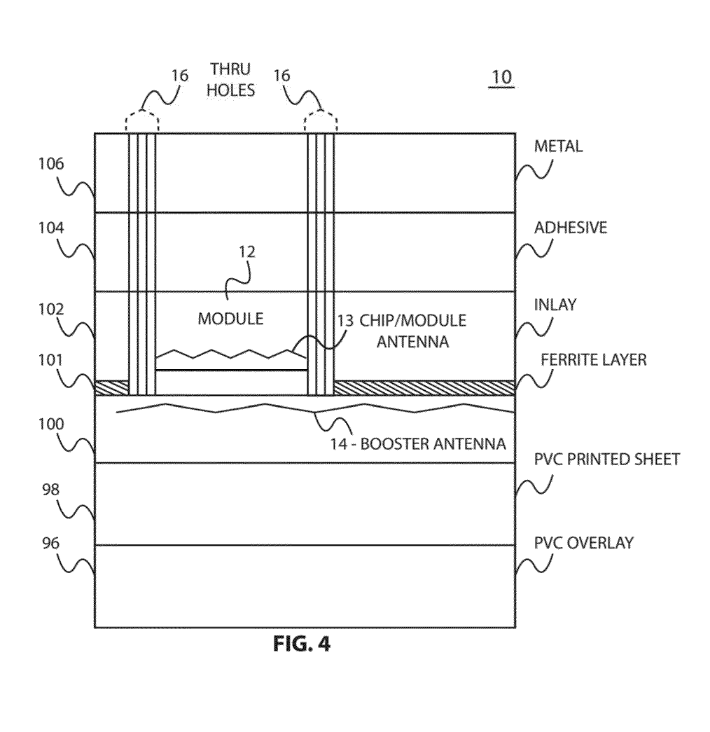

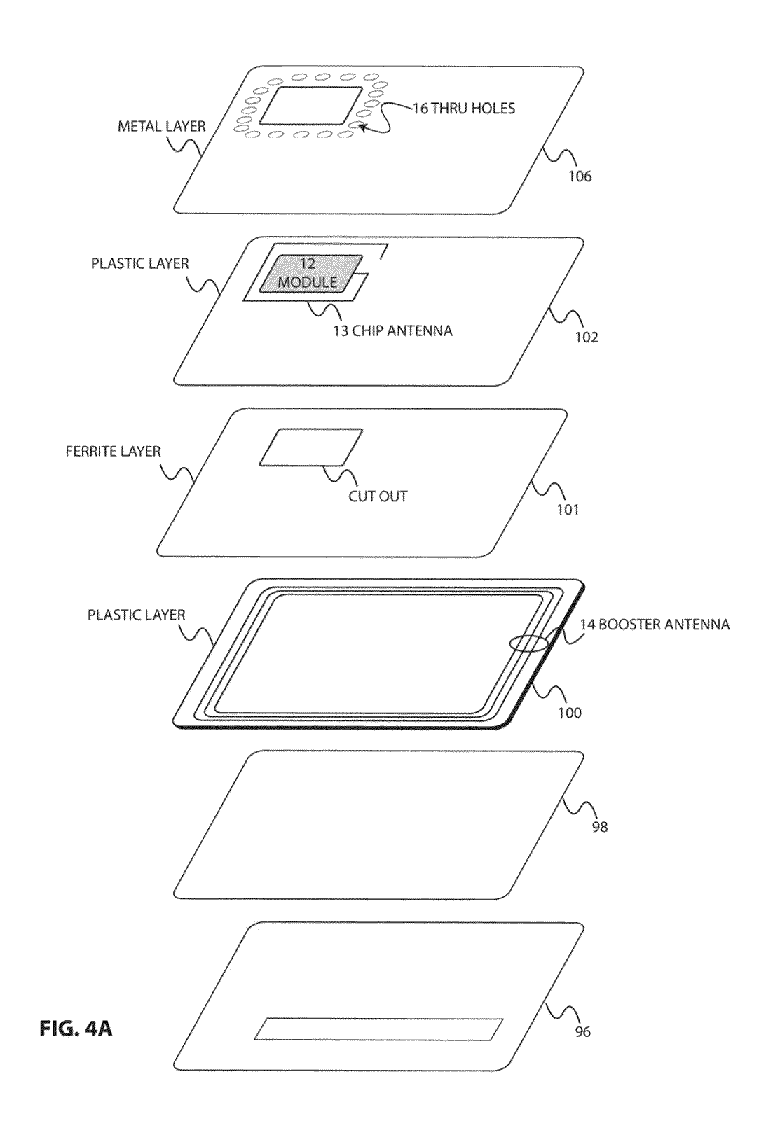

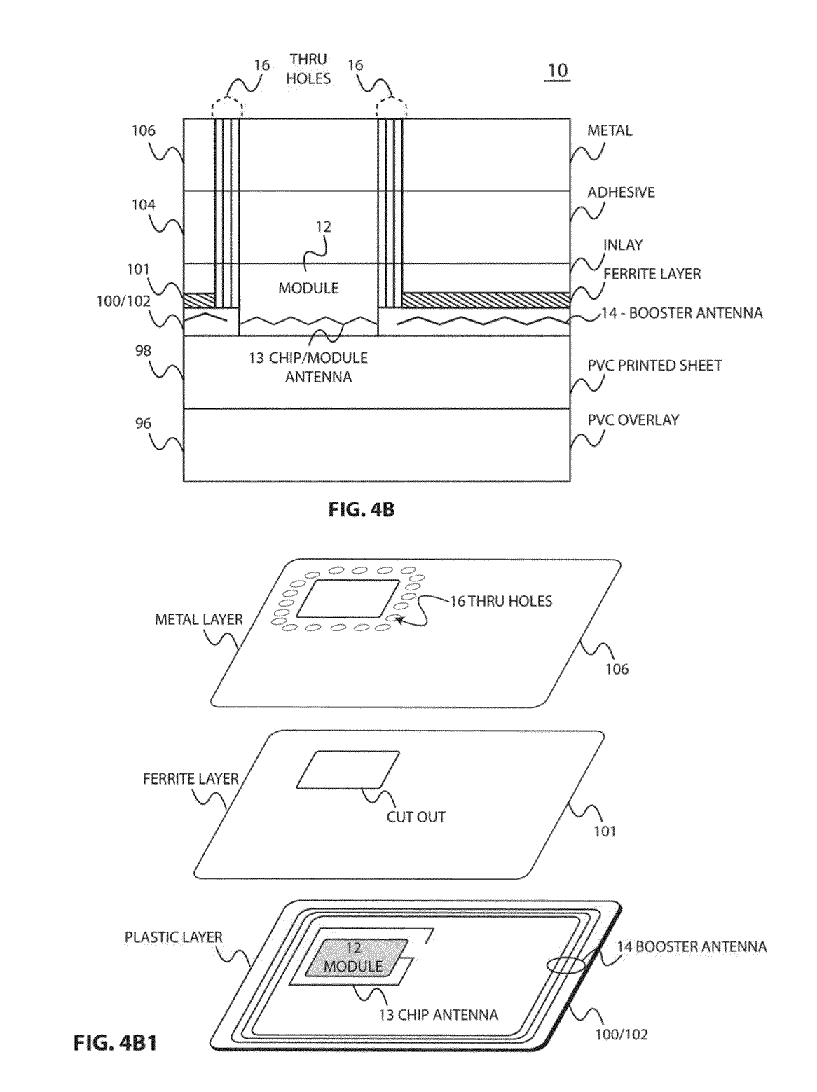

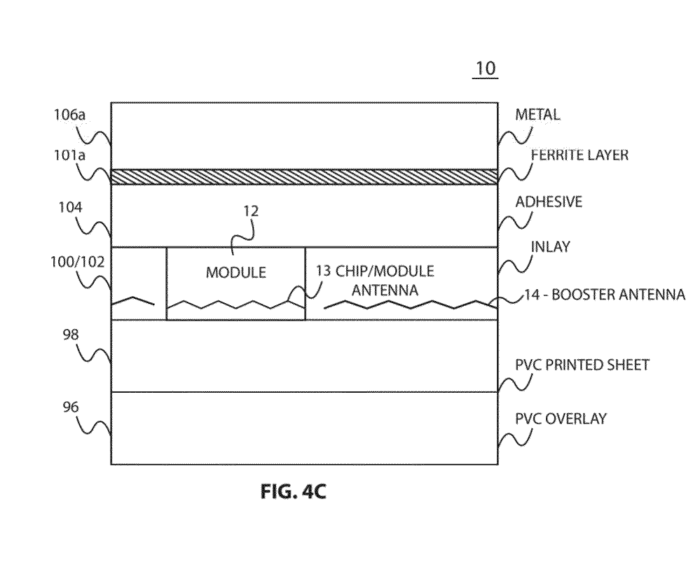

FIG. 4 is similar to FIG. 1 except that a ferrite layer 101 is formed between the layer 102 on which the module 12 is mounted and the layer 100 on which the booster antenna 14 is mounted. FIG. 4A is an isometric diagram showing a blow up of the layers of FIG. 4 stacked one upon the other.

Going from the bottom to the top of the card 10, as shown in FIGS. 4 and 4A, a PVC printed sheet layer 98 overlies the bottom most PVC overlay layer 96. A layer 100 overlying layer 98 includes booster antenna 14. Overlying layer 100 is a ferrite layer 101 which includes an opening (identified as a “cut out” in layer 101 of FIG. 4A) under the area covered by the module 12 and the thru holes. The “cut out” is normally made large than the area (e.g., 0.5 inches by 0.5 inches) of the module. A layer 102 on which is mounted the module 12, which includes a (micro)computer chip and its associated module antenna 13, overlies the ferrite layer 101. An adhesive layer 104 is used to attach layer 102 to overlying metal layer 106 which includes thru-holes in the area overlying and surrounding the module 12.

The introduction of a ferrite layer 101 is very significant in that it functions to offset the attenuating (grounding) effect of the metal layer 106 on RF signals reception and transmission. For purpose of explanation, referring to FIG. 4, assume that RF signals travel to and from the inductors/antennas 13 and 14 either: (a) from the top of the card through thru-holes 16; or (b) from the bottom side of the card through layers 96, 98 and 100. By way of example, the RF signals travelling from the bottom side of the card through layers 96, 98 and 100 impinge on booster antenna 14 and as these signals travel further they meet the ferrite layer 101 which functions to reflect the signals back toward the booster antenna 14 which is inductively coupled to the module antenna 13. The increased energy is coupled by antenna 13 to the computer chip of module 12. The ferrite layer 101 thus tends to offset the attenuation introduced by the metal layer 106 by creating an insulating layer to the RF signals. The RF signals travelling from the top of the card passes through the thru-holes 16 and the space around the module 12 to impinge on the booster antenna 14 and the module antenna 13.

The ferrite layer material may be a microscale, printed, iron alloy ferrite material. The ferrite layer may be comprised of naked ferrite micro particles or of nanoparticles as well as particles coated with polymer to promote adhesion to the carrier. The use of a ferrite layer with nanoparticles is particularly significant as, at that size, the material is superparamagnetic. The ferrite may be selectively placed on the carrier for this product in order to coincide with the passage of the RF flux through the holes and module aperture. The ferrite may be applied in a manner similar to laser jet printing. In a particular method, an electrostatic charge is applied to a rotating drum in the desired pattern, which picks up the ferrite. The patterned ferrite is deposited on the carrier material in the proper pattern and heat bonded to the carrier.

A smart card formed with a ferrite layer 101 as shown in FIG. 4 can reliably be used for contactless operation with a card reader positioned 1 cm from the top of the card and 4 cm from the bottom of the card.

The configuration shown in FIGS. 4B and 4B1 is similar to the configuration shown in FIGS. 4 and 4A, except that the module 12, the module antenna 13 and the booster antenna 14 are mounted on the same side of the layer 100/102. That is, the module 12, the module antenna 13 and the booster antenna 14 are being carried by the same plastic layer denoted as an inlay 100/102. In this embodiment the ferrite layer 101 is shown to overlay the booster antenna 14 and the module antenna 13. The module 12 may extend through an opening (cut out) in the ferrite layer as shown in FIG. 4B1, which allows the creation of dual interface cards.

In the embodiments shown in FIGS. 4, 4A, 4B and 4B1, the contactless card may be accessed by a card reader from the top or the bottom, although as already noted the operable range is greater from the non-metallic side of the card.

In FIG. 4C there is shown a smart card where a solid metal layer 106a (i.e., a metal layer which is not modified with holes or cut outs) overlies a solid ferrite layer 101a which overlies a layer 100/102 containing a module 12, a module antenna 13 and a booster antenna 14. In this configuration, a card reader can still reliably access the smart card 10a from the bottom side via layers 96, 98. FIG. 4C is an example of a contactless card which is operable in essentially one direction (i.e., signals can be applied and read from the non-metallic side of the card).

FIG. 5 shows a module 12a located within a cutout of the metal layer 106. In FIG. 5 the metal layer 106 includes thru holes 16 located around the module. The metal layer is positioned over the ferrite layer 101, which improves efficient coupling of signals as discussed above, which overlies plastic layer 100 which includes the booster antenna 14, as described above. In FIG. 5 the cut out for the module 12a extends through the full thickness of the metal layer 106. The thru-holes extend through the full thickness of the metal layer 106 and the ferrite layer 101.

The module 12a, as shown in FIG. 5A, includes a microprocessor (also referred to as a semiconductor chip or integrated circuit, IC) coupled to an internal coupling module antenna 13 and to a contact assembly including contacts 121, 123 to enable contact to an external device (e.g., a contact card reader). FIGS. 5 and 5A thus show a dual interface, smart metal card, which can be accessed and used by, either a contactless card reader or a contact card reader.

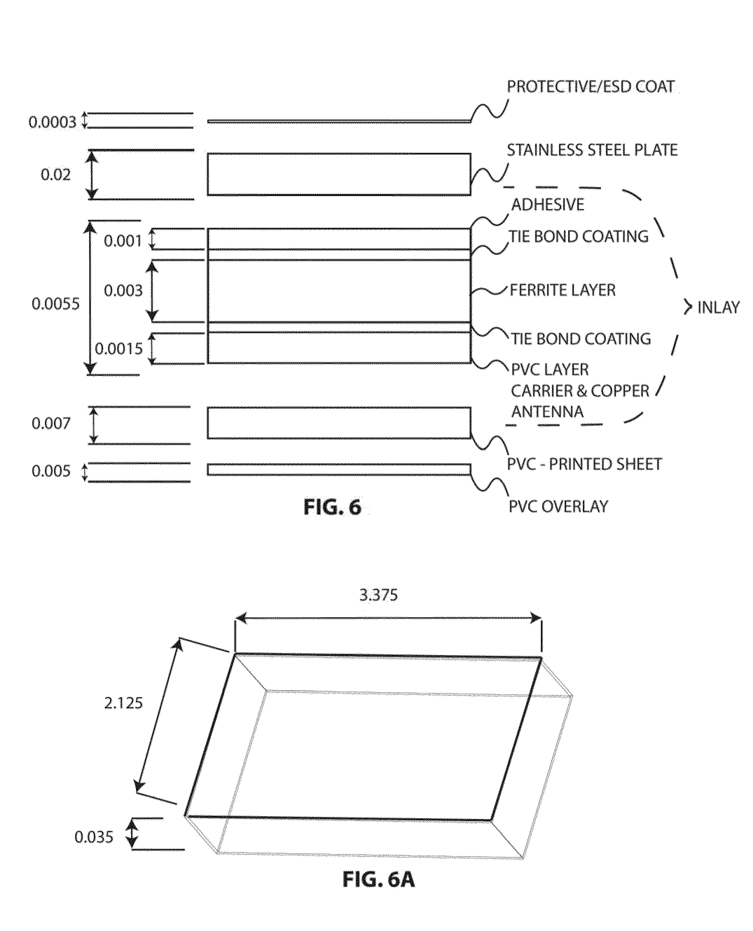

FIGS. 6 and 6A provide a detailed cross section of a metal clad card embodying the invention with dimensions given in inches. In FIG. 6 there is shown the PVC-printed sheet layer overlying the outer PVC overlay layer. An inlay is formed between the PVC printed sheet layer and the stainless steel layer. The inlay includes a module the booster antenna and a ferrite layer located between the steel plate and the booster antenna. As discussed above, a protective ESD coat overlies the assembly. The card may have a length of approximately 3.3 inches, a width of approximately 2.1 inches and a thickness of approximately 0.035 inches. The module (not shown) has an area of approximately 0.5 inches by 0.5 inches.

Thus, in accordance with the invention a smart card can be formed having a metal layer which may be reliably accessed by a card reader in a contactless and/or in a contact mode.

What is claimed is:

1. A card comprising:
a first plastic layer having first and second substantially planar surfaces extending for a length L and a width W and having a surface area A equal to (L)(W);
a module including a computer chip mounted on said first surface of said first plastic layer, said module occupying a small fraction of the surface are of said first surface;
a metal layer of given thickness overlying the semiconductor chip and overlying essentially the entire first planar surface area of said first plastic layer;
an antenna system inductively coupled to said computer chip for enabling radio frequency (RF) signals to be received and coupled to said computer chip; and
said metal layer characterized in having multiple distinct apertures extending through the full thickness of the metal layer in an area overlying and surrounding the semiconductor chip for enabling RF signals received from, or transmitted to, a card reader to pass through the apertures.

2. A card as claimed in claim 1 wherein said apertures are thru-holes less than 0.02 inches in diameter so as to be hardly perceptible and so as not to alter the appearance of the metal layer.

3. A card as claimed in claim 1 wherein said apertures are slits.

4. A card as claimed in claim 1 wherein said antenna system includes a module antenna connected to said computer chip and a booster antenna mounted on a second plastic layer located below said second planar surface of said first plastic layer.

5. A card as claimed in claim 4 wherein there is further included a ferrite layer between said first and second layers.

6. A card as claimed in claim 1, further including a ferrite layer between the metal layer and said first plastic layer.

7. A card as claimed in claim 1, wherein there is a cut out in the metal layer overlying said module for exposing the module fully.

8. A card comprising:
a metal layer, a ferrite layer, and a plastic layer on which is mounted a module containing a computer chip coupled to an antenna system; and
wherein said ferrite layer is positioned between said metal layer and said antenna system to reduce the attenuation effect of the metal layer on radio frequency (RF) signals and for enabling radio frequency (RF) signals to be received and transmitted between said antenna system and a card reader.

9. A card as claimed in claim 8 wherein said module mounted on said plastic layer includes a computer chip and an associated module antenna and wherein said antenna system includes a booster antenna also mounted on said plastic layer.

10. A card as claimed in claim 8 wherein said module mounted on said plastic layer includes a computer chip and an associated module antenna and wherein said antenna system includes a booster antenna located below said plastic layer and below said ferrite layer.

11. A card as claimed in claim 8 wherein said metal layer is modified in having a selected number of thru-holes formed through the thickness of the metal layer in an area of the metal layer surrounding and overlying the module.

12. A card as claimed in claim 8 wherein said metal layer is modified in having a cut out formed through the thickness of the metal layer in an area of the metal layer surrounding and overlying the module.

13. A card as claimed in claim 8 wherein said ferrite layer is comprised of nanoparticles.

14. A card as claimed in claim 8 wherein said metal layer is modified in having a selected number of thru-holes formed through the thickness of the metal layer in an area of the meal layer surrounding and overlying the module; and wherein said ferrite layer extends under the metal layer except for the area underlying the module and the through holes.

15. A card as claimed in claim 8 wherein said metal layer is modified in having a cut out formed through the thickness of the metal layer in an area of the metal layer surrounding the module and wherein said metal layer is modified in having a selected number of thru-holes formed through the thickness of the metal layer in an area of the metal layer surrounding the module.

16. A card as claimed in claim 8 wherein said ferrite layer has a cut out formed in an area corresponding to the area of the module.
